(19) United States
(12) Patent Application Publication
(10) Pub. No.: US 2003/0055981 A1
(43) Pub. Date: Mar. 20, 2003

(54) Provision of call features

(76) Inventors: Jose Costa Requena, Helsinki (FI); Vesa Hakkarainen, Tampere (FI)

Correspondence Address: PERMAN & GREEN, 425 POST ROAD, FAIRFIELD, CT, 06824, US

(21) Appl. No.: 09/957,993

(22) Filed: Sep. 20, 2001

(51) Int. Cl. G06F 15/16

(52) U.S. Cl. 709/227; 709/230

(57) ABSTRACT

The invention relates to a method for providing call features to an IP endpoint of a communications system during an initialization of a session between at least two IP endpoints of said system. The session is initialized by transmitting messages defined in a SIP (session initiation protocol) between a first IP endpoint of the communications system and at least a second IP endpoint of the communications system. In order to improve the provision of call features, it is proposed that messages defined in the SIP are used in addition during the initialization for transmitting data required for a set of desired call features from the first IP endpoint to the at least second IP endpoint. Equally proposed are corresponding IP endpoints and a corresponding communications system.

### FIELD OF THE INVENTION

The invention relates to a method for providing call features to an IP (internet protocol) endpoint of a communications system during an initialization of a session between at least two IP endpoints of said communications system, wherein said session is initialized by transmitting messages defined in a SIP (session initiation protocol) between a first IP endpoint of said communications system and at least a second IP endpoint of said communications system. The invention equally relates to a corresponding first and second IP endpoint and to a communications system comprising such IP endpoints.

### BACKGROUND OF THE INVENTION

SIP is an IETF (Internet Engineering Task Force) protocol which is defined e.g. in the Request for Comments (rfc) 2543bis-02: “SIP: Session Initiation Protocol”, of Sep. 4, 2000, which is incorporated by reference herein.

SIP constitutes an application-layer control protocol that can establish, modify and terminate multimedia sessions or calls between two or more parties in an IP network. To this end, a variety of SIP messages are defined for transmitting information between different parties, which SIP messages are also referred to as methods. SIP enables for instance to determine the willingness of a called party to engage in a requested communication, and to set up a call by establishing call parameters at both called and calling party. The involved parties can be not only persons, but also for instance media storage services. Any device that might be employed for participating in a session, e.g. a terminal employed by a user or a server employed for providing a service, will also be referred to as endpoint.

In 3GPP (3rd generation partnership project), which offers specifications for 3G (3rd generation) systems, SIP is to be employed for call control and signaling functions when IP technology is to be used end-to-end for delivering multimedia content to mobile handsets. Users in such a system can be identified by SIP URLs (uniform resource locator), which constitute links to a resource, and/or by the numbering system of the telephone system. For an instant messaging (IM) subsystem of 3G mobile networks, 3GPP has defined a Call State Control Function (CSCF) in the network. This function controls the call signaling of IP endpoints. The protocol used between an IP endpoint and CSCF for initiating a call is SIP.

SIP enables in addition several enriching call features which can be employed as well for 3G mobile networks. Such call features may include sending a caller image, a ringing tone or a business card with the incoming call. Such call features are also referred to by rich CLIP (Calling Line Identification Presentation). In order to transfer the data related to a call feature to a receiving end, it was suggested in the rfc 2543 that the data is first stored on some server. A SIP message transmitted from a calling party to a called party is then used to identify a link to the data stored on the server. More specifically, an INVITE message used according to SIP for initiating a call signaling can have a Call-Info header which contains an URI (uniform resource indicator) to supplementary call information on a server. Such an INIVTE message can equally include an Alert-Info header which contains a URI to data for a specific ringing tone stored in a server.

After having received this indication, the called party is then able to retrieve the data for supplementary information or a ringing tone from the server using an additional suitable protocol, e.g. HTTP (hypertext transport protocol), which is an IETF standard for distributed, collaborative, hypermedia information systems.

It is a disadvantage of the method proposed in rfc 2543 that it requires a network server that can be used for storing the binary data. It is also a disadvantage that it requires an implementation of an additional protocol in the endpoints for storing data to the server as well as for retrieving the data from the server. Moreover, a modification of data that is to be provided during the initialization or modification of a session has to be carried out by modifying the data stored in the server.

### SUMMARY OF THE INVENTION

It is an object of the invention to enable an improved implementation of a call feature service, e.g. a rich CLIP service. It is in particular an object of the invention to enable a cheaper implementation of a call feature service.

The objects of the invention are reached on the one hand with a method for providing call features to an IP endpoint of a communications system during an initialization of a session between at least two IP endpoints of the system. The session can be for instance a call or any other kind of session in which information is transmitted between different endpoints. The session is initialized by transmitting messages defined in a SIP between a first IP endpoint of the communications system and at least a second IP endpoint of the communications system. It is to be noted that the first IP endpoint can but does not necessarily have to participate in the session itself. Messages defined in the SIP are used in addition during the initialization for transmitting data, in particular binary data, required for a set of desired call features from the first IP endpoint to the at least second IP endpoint. The messages can be messages that are defined explicitly for the transmission of data for the desired call features, or messages that are used at the same time for other purposes in an initialization of a session, or a mixture of both.

On the other hand, the objects of the invention is reached with a communications system. The proposed system comprises at least a first IP endpoint and a second IP endpoint with an implementation of a SIP. The first IP endpoint further includes means for assembling messages defined in said SIP for initializing a session between at least two IP endpoints of said system. These means are used in addition for assembling messages defined in the SIP and comprising data for a set of desired call features. The call features are to be provided to at least one IP endpoint of said communications system during said initialization. The first IP endpoint finally includes means for transmitting the assembled messages to said at least one IP endpoint. The second IP endpoint, which can constitute the mentioned at least one IP endpoint, includes means for receiving messages defined in the SIP and comprising data required for call features. The second IP endpoint moreover includes means for extracting said data from said received messages, and means for presenting said call features to a user of the second IP endpoint based on the extracted data.

The objects of the invention are equally reached with such IP endpoints.

The invention proceeds from the idea that the transmission of data required for call features between IP endpoints can be facilitated by transmitting this data directly from the first endpoint to the at least second endpoint. Transmitting the data directly does not exclude that the data can be forwarded on the route from one endpoint to another by one or more servers. Transmitting the data directly rather means without storing the data first in some server, from which the receiving endpoint or endpoints have to retrieve the data.

It is an advantage of the invention that it avoids the need for a network server on which the data can be stored, and thus the costs for purchasing and supporting a server. It is a further advantage of the invention that no additional suitable protocol implementation and application is required in the endpoints which enable to add information for a call feature to a server and which enable to fetch the information from the server. Consequently, less memory is needed in the endpoint providing a call feature and in the endpoint receiving a call feature. In addition, modified information does not have to be updated in the server. New information, e.g. data for a photo, can simply be saved in an endpoint that may want to provide a modified call feature. Then, the new information can be sent directly to a receiving endpoint, for instance together with the signaling for the establishment of a call.

Preferred embodiments of the invention become apparent from the subclaims.

The set of desired call features may comprise one or several call features. It can include in particular information selected by a caller using the first endpoint, for instance a caller image, a business card and/or a ringing tone.

SIP messages or requests as defined in rfc 2543 consist of a start-line, one or more header fields, an empty line indicating the end of the header fields, and an optional message-body.

The data required for the set of desired call features is advantageously inserted into the message-body of messages which are announced in header fields of a first message.

The first message can be in particular a SIP INVITE message. According to SIP, this INVITE message initiates the call signaling that is used by one endpoint to invite one or more other endpoints to participate in a session that is to be established or to a session that has already been established. The INVITE message typically contains a session description that provides the called party with enough information to join the session. According to the invention, the INVITE message can include in addition information about further messages carrying the required data.

The announced further messages in which the data is included could be any suitable SIP messages, e.g. MESSAGE methods. However, since the call features may have to transverse 2G (2nd generation) networks, preferably the employed subsequent messages are INFO messages, which can also be understood by the current 2G gateways. Even more preferably, though, the invention is realized in a flexible way. That means, in the case that only IP networks are involved in the transmission of the SIP messages, MESSAGE methods are used for carrying the data required for a set of desired call features, while in the case that the IP endpoints have to exchange the information via 2G networks, INFO methods will be used for carrying this data. A “method”-tag could be employed to indicate in which kind of message the data is carried.

Preferably, at least one further message is transmitted for each desired call feature of a set. Depending on the required data amount, the data for a single call feature can moreover be distributed to two or more messages. This can be of particular interest for the data required for a caller image.

The first message and the further messages can contain in their header fields any information that may be useful to the at least second endpoint for processing the data received in further messages correctly. This information may include in particular the type of the desired call features and the number of messages used to carry the data required for these call features.

Preferably, information relating to the transmission of data for the set of desired call features in the first message and/or the further messages are described by an XML (extended markup language) script. Any type of XML could be used.

According to SIP, each message comprises a Call-ID general-header field, which uniquely identifies a particular invitation or all registrations of a particular client. A single multimedia conference can give rise to several calls with different Call-Ids. By including different Call-Ids in a header of the INVITE message as first message and in a header of the announced further messages, the standard call signaling can be preserved.

In a preferred embodiment, an endpoint according to the invention has a SIP stack offering an interface to an application that implements the invention by initiating a desired service through the application interface.

The invention can be employed in particular, though not exclusively, for 3G mobile terminals and 3G mobile networks.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are merely intended to conceptually illustrate the procedures described herein.

### BRIEF DESCRIPTION OF THE FIGURES

In the following, the invention is explained in more detail with reference to drawings, of which

FIG. 1 shows a first part of a message sequence chart for an embodiment of the invention;

FIG. 2 shows a second part of a message sequence chart for an embodiment of the invention; and

FIG. 3 shows a third part of a message sequence chart for an embodiment of the invention.

### DETAILED DESCRIPTION OF THE INVENTION

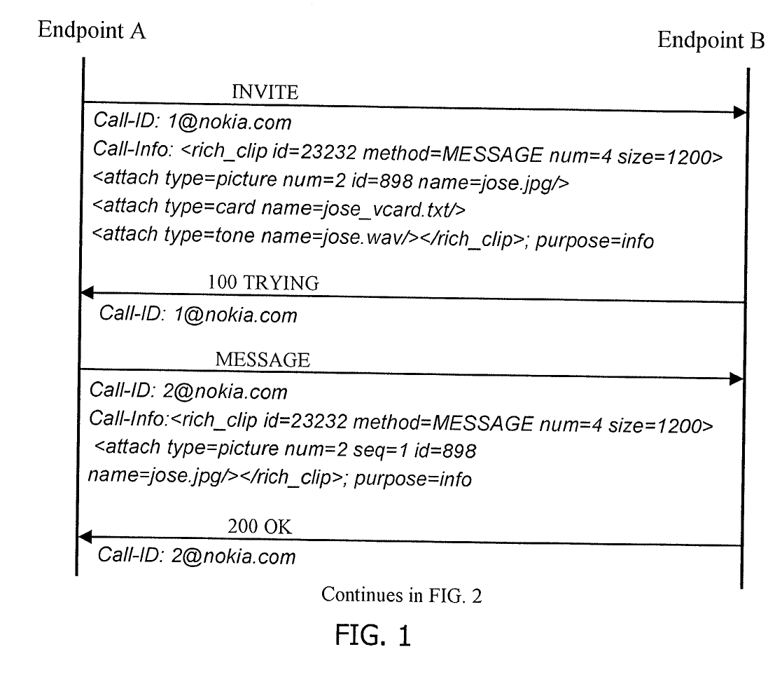

An embodiment of the invention will be described with reference to a message sequence chart which was distributed to FIGS. 1 to 3. The embodiment allows to provide in a 3G system rich CLIP features from a calling IP terminal to a called IP terminal.

A vertical line on the left hand side of each figure represents a first IP terminal, endpoint A. A vertical line on the right hand side of each figure represents a second IP terminal, endpoint B. Horizontal lines between the two vertical lines indicate SIP messages transmitted between the two endpoints A, B for a specific exemplary situation. The direction of the respective message is indicated by arrows.

Even though the SIP signaling is depicted in the figures as direct connection between the two endpoints A, B, the messages could also be transmitted via one or more proxy servers between the two endpoints A, B. This would not change the contents of the messages in a way that affects the invention.

For each transmitted SIP message, the message sequence chart shows the name of the message above the respective horizontal line and in addition a Call-ID header and possibly a Call-Info header below this horizontal line. There may be other headers in the signaling, but only these headers are relevant for the invention. The contents of the headers are distributed to several lines in the message sequence chart for reasons of presentation. In reality, header and content are arranged in a single line.

A user of endpoint A now wants to establish a call to the user of endpoint B. The initialization of the call is to include rich CLIP features. More specifically, a caller image, a ringing tone and a business card are to be delivered to endpoint B.

As shown in FIG. 1, the initialization of the call is started with an INVITE message transmitted from endpoint A to endpoint B. The INVITE message includes a Call-ID header and a Call-Info header. A Call-ID header is included in every SIP message, and has in this example the value 1@nokia.com.

The Call-Info header contains an XML script which presents further details on how subsequent messages carry the desired rich CLIP features. The Call-Info header comprises to this end information in 5 pairs of brackets. The first brackets contain general information on the rich CLIP features, and the second to fourth brackets contain information relating to one of the three desired call features respectively. The fifth bracket terminates the rich CLIP related part of the Call-Info header. An entry “rich_clip” at the beginning of the first bracket and as only entry in the last bracket indicate that one or more messages containing rich CLIP information will follow after the INVITE message.

In the first bracket, a further entry “id=23232” defines a temporary identity for the rich CLIP. The value of the identity will be used only for this rich CLIP. The following entry “method=INFO” indicates that subsequent INFO messages will be used to carry the rich CLIP. Four such INFO messages will be used for transmitting the desired rich CLIP features, which is indicated by the entry “num=4”. An entry “size=1200” indicates that the maximum size of the binary information in the INFO messages will be 1200 bytes. This information can be used in endpoint B for example to allocate memory.

The second brackets define a first attachment in subsequent INFO messages, indicated by a first entry “attach”. This first attachment is included for the first desired call feature, the caller image. The attachment thus relates to a picture, which is indicated by the entry “type=picture”. The entry “num=2” defines that there will be two INFO messages employed for transmitting the data of the caller image. All INFO message carrying data for the caller image will use an identification number 898 according to the entry “id=898”. A last entry is the name of the caller image “name=jose.jpg”. The identification number is used in addition to the name of the picture, since there could be more than one picture with the same name to be delivered. Since the INFO messages might arrive out of order, it has to be clearly indicated which INFO message carries data for which picture.

The third brackets are assigned to the attachment for the second call feature, i.e. the business card that is to be transmitted. Following the entry “attach”, the type of the attachment is therefore set to “type=card”. The name of the card that is to be transmitted is “name=jose_vcard.txt”. An indication of the number of messages and of an additional identification of the card is not included in this case, since only a single INFO message will be required for transmitting the binary data for the business card.

The entries of the fourth brackets correspond to the entries of the third brackets, except that they announce an attachment of a ringing tone named jose.wav, thus in this case the entry indicating the type of the call feature is “type=tone” and a the entry indicating the name of the call feature “name=jose.wav”.

An indication “purpose=info” after the last brackets of the INVITE message is a standard SIP parameter.

The INVITE message is transmitted from endpoint A to endpoint B and is confirmed by endpoint B with a message 100 TRYING, which contains a Call-ID header as every SIP message. The Call-ID is the same as in the INVITE message, i.e. “Call-Id=1@nokia.com”. This confirmation by a 100 message is standard SIP signaling, but in this case it is also obligatory, because if endpoint B supports the reception of data for call features according to the invention, it cannot continue immediately with the call establishment. It rather has to wait for the announced INFO messages first. Endpoint A, however, will send the announced INFO messages even if endpoint B did not understand the meaning of the Call-Info header in the INVITE message. In this case, endpoint B would discard the INFO messages and continue with a normal call establishment.

After the INVITE message, endpoint A sends a first INFO message to endpoint B. This INFO message is the first of the two messages announced for the caller image. The header Call-ID is set to “Call-ID: 2@nokia.com”. The Call-ID has thus a different value than in the INVITE message. This way normal call signaling is preserved for the case that endpoint B does not support the invention. Also the other INFO messages will have different Call-ID values. The INFO message further contains as well a Call-Info header. This Call-Info header comprises three brackets.

The first brackets of the Call-Info header contain the identical information as the first brackets of the Call-Info header of the INVITE message. The contents of these brackets are used to map the rich CLIP to the correct call.

The second brackets comprise the same entries “attach”, “type=picture”, “num=2”, “id=898” and “name=jose.jpg” as the second brackets of the Call-Id header of the INVITE message. In this case, however, an additional entry “seq=1” is provided, which indicates that this INFO message contains the first part of the two INFO messages transmitted for this call feature.

The entry in the third brackets, “rich_clip”, delimits again together with the first entry in the first brackets the contents that belong to the rich CLIP information in this header. An indication “purpose=info” after the last brackets of the INFO message is a standard SIP parameter.

Following the header part after an empty line, the INFO message comprises a message-body including the first binary data for the caller image that is to be transmitted as first call feature. This binary data is indicated in the figure by “ . . . aabbcc1223 . . . ”.

Endpoint B responds with a 200 OK message including the same Call-ID “2@nokia.com” as the INFO message, which is again a standard SIP response. This 200 OK message is the last message of the part of the message sequence chart shown in FIG. 1.

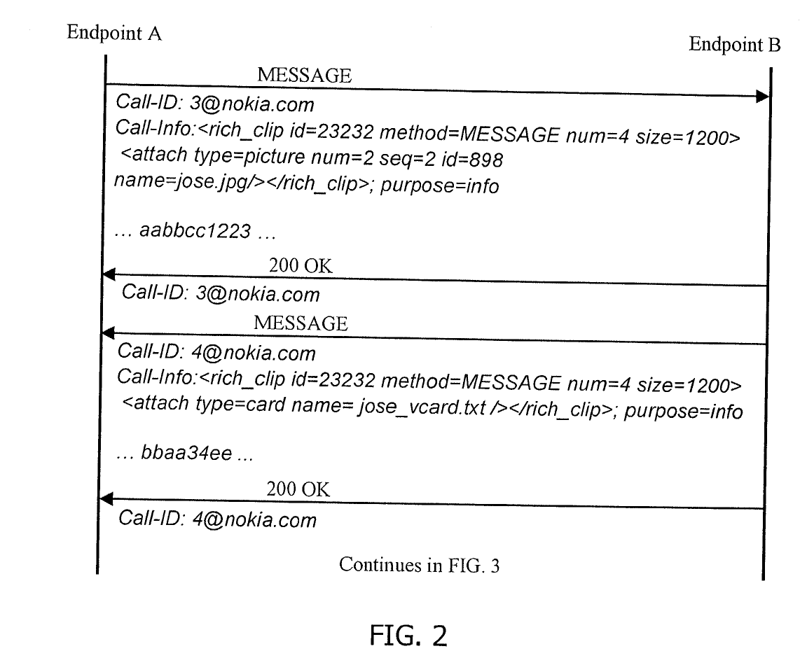

The next INFO message, which is the first message of the part of the message sequence chart shown in FIG. 2, has a very similar content as the first INFO message. The only difference in the header part is that the Call-ID header has another value “3@nokia.com”, and that the entry in the Call-Info header indicating the part of the binary data for the caller image included in this message is changed to “seq=2”, since this INFO message contains the second part of the two parts of the data for the caller image. Accordingly, also the binary data “ . . . aabbcc1223 . . . ” included in the message-body of the second INFO message is different from that in the first INFO message. The second INFO message is equally answered by endpoint B with a 200 OK message, this time including a Call-ID header with a value of “3@nokia.com”. This 200 OK message is the last message of the part of the message sequence chart shown in FIG. 2.

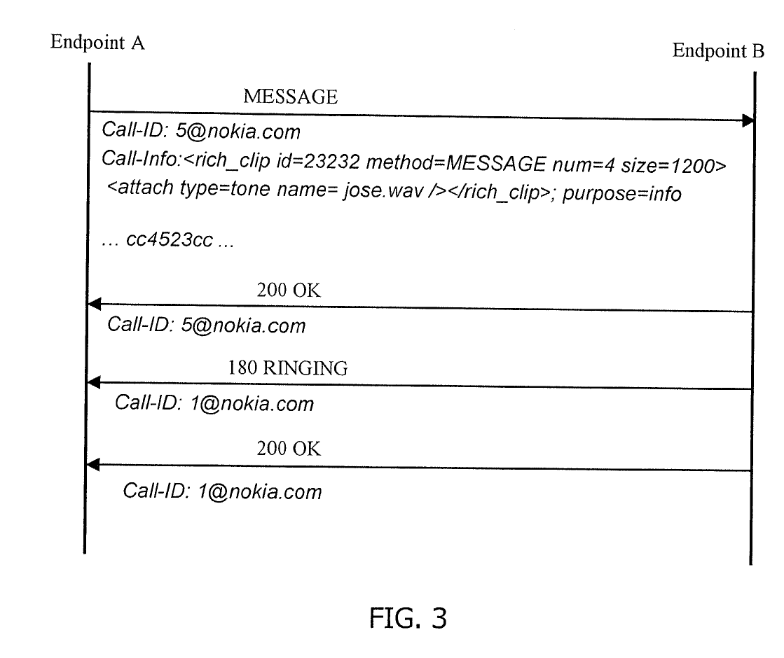

A third INFO message transmitted from endpoint A to endpoint B is employed for the transmission of the data for the business card. This INFO message is the first message of the part of the message sequence chart shown in FIG. 3. The structure of the message is the same as the structure of the previous INFO messages. Again, a dedicated Call-Id header value “4@nokia.com” is provided. The Call-Info header comprises first brackets which are identical to the first brackets of the INVITE message with the entries “rich_clip” “id=23232”, “method=INFO”, “num=4”, and “size=1200”. The second brackets of the Call-Info is identical to the third brackets of the INVITE message with the entries “attach”, “type=card”, and “name=jose_vcard.txt”. The header is delimited again by third brackets with an entry “rich_clip”, which are followed by the standard SIP parameter “purpose=info”.

The message-body of this INFO message contains the binary data “ . . . bbaa34ee . . . ” required for the business card that is to be presented to endpoint B.

Also the third INFO message is answered by endpoint B with a 200 OK message. It includes a Call-ID header with a value of “4@nokia.com”.

The fourth and last INFO message is employed for the transmission of the ringing tone. The structure is the same as the structure of the previous INFO messages. A dedicated Call-Id header value of “5@nokia.com” is provided. The Call-Info header comprises first brackets which are identical to the first brackets of the INVITE message with the entries “rich_clip” “id=23232”, “method=INFO”, “num=4”, and “size=1200”. The second bracket of the Call-Info is identical to the fourth brackets of the INVITE message with the entries “attach”, “type=tone”, and “name=jose.wav”. The header is delimited again by the third brackets with the entry “rich_clip”. The header is delimited again by third brackets with an entry “rich_clip”, which are followed by the standard SIP parameter “purpose=info”.

The payload section of the last INFO message contains the binary data “ . . . cc4523cc . . . ” for the ringing tone that is to be employed for alerting the called party.

Also the fourth INFO message is answered by endpoint B with a 200 OK message. It includes a Call-ID header with a value of “5@nokia.com”.

Now, endpoint B can transmit a regular 180 RINGING message to endpoint A, this time again with a Call-ID header with a value of “1@nokia.com”. Endpoint B sends in addition a 200 OK message to endpoint A in order to accept the invitation, i.e. the first INVITE method. This 200 OK message is the last message of the message sequence chart shown in FIGS. 1 to 3.

The caller image could be shown to the called party using endpoint B when the incoming call is reported, and the ringing tone could be used to alert the called party. The business card could be shown instead of the caller image or saved to endpoint B. It is up to the application what to do with image, tone and card.

While there have shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. In particular, the fields of the headers of the presented messages can be distributed in any other order or filled with any other suitable information which enables a receiving end to extract the data for the desired call features correctly and to present the desired call features correctly to the user. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for providing call features to an IP (internet protocol) endpoint of a communications system during an initialization of a session between at least two IP endpoints of said communications system, wherein said session is initialized by transmitting messages defined in a SIP (session initiation protocol) between a first IP endpoint of said communications system and at least a second IP endpoint of said communications system, and wherein messages defined in said SIP are used during said initialization for transmitting data required for a set of desired call features from said first IP endpoint to said at least second IP endpoint.

2. A method according to claim 1, wherein said initialization comprises
assembling and transmitting a first message from said first IP endpoint to said at least second IP endpoint, which first message includes an announcement of at least one further message containing binary data for at least one desired call feature;
assembling and transmitting said at least one further SIP message announced in said first message from said first IP endpoint to said at least second IP endpoint.

3. A method according to claim 2, wherein said first message is an INVITE message defined in said SIP, which INVITE message further includes an invitation to said at least second IP endpoint to participate in a session.

4. A method according to claim 2, wherein said at least one further message is an INFO message defined in said SIP.

5. A method according to claim 2, wherein said at least one further message is a MESSAGE method defined in said SIP.

6. A method according to claim 1, wherein said set of desired call features comprises information selected by a caller using said first IP endpoint.

7. A method according to claim 6, wherein said information provided by said caller includes at least one of a caller image, a business card, and a ringing tone.

8. A method according to claim 2, wherein said announcement of at least one further message in said first message comprises at least one of the following:
an indication that said first message comprises information on call features;
an identification of said set of desired call features;
an indication of the type of said further messages;
an indication of the number of said further messages; and
an indication of the maximum amount of binary data included in said further messages.

9. A method according to claim 2, wherein said announcement of at least one further message in said first message comprises for each call feature of said set of desired call features at least one of the following:
an indication of the type of the respective call feature;
an indication of the number of further messages containing binary data for the respective call feature;
an identification of the respective call feature; and
an indication of a name of the respective call feature.

10. A method according to claim 2, wherein at least one further message is announced and assembled for each call feature of said desired set of call features, and wherein each of said at least one further message comprises in a header section at least one of the following:
an indication that the respective further message relates to a call feature;
an identification of said set of desired call features;
an indication of the type of the respective further message;
an indication of the total number of said further messages;
an indication of the maximum total amount of data included in said further messages;
an indication of the type of the respective call feature for which the respective further message is assembled;
an indication of the number of further messages assembled for the respective call feature;
an indication of the position of the respective further message among all further messages provided for the same call feature;
an identification of the call feature for which the respective further message is assembled; and
an indication of a name of the call feature for which the respective further message is assembled.

11. A method according to claim 2, wherein each of said at least one further message comprises a message-body for receiving at least a part of binary data required for at least one call feature of said set of desired call features.

12. An IP (internet protocol) endpoint of a communications system comprising
an implementation of a SIP (session initiation protocol);
means for assembling messages defined in said SIP for initializing a session between at least two IP endpoints of said communications system, said means being used in addition for assembling messages defined in said SIP and comprising data for a set of desired call features, which call features are to be provided to at least one IP endpoint of said communications system during said initialization; and
means for transmitting said assembled messages to said at least one IP endpoint.

13. An IP endpoint according to claim 10 comprising a SIP stack in which said SIP is implemented, which SIP stack has an application interface for enabling an application to initiate an assembling of messages with said data for said set of desired call features.

14. An IP (internet protocol) endpoint of a communications system comprising an implementation of a SIP (session initiation protocol), means for receiving messages defined in said SIP and containing data required for call features, means for extracting said data from said received messages, and means for presenting said call features to a user of said IP endpoint based on said extracted data.

15. A communications system comprising at least
a first IP (internet protocol) endpoint with an implementation of a SIP (session initiation protocol), with means for assembling messages defined in said SIP for initializing a session between at least two IP endpoints of said communications system, said means being used in addition for assembling messages defined in said SIP and comprising data for a set of desired call features, which call features are to be provided to at least one IP endpoint of said communications system during said initialization, and means for transmitting said assembled messages to said at least one IP endpoint; and
a second IP endpoint with an implementation of a SIP (session initiation protocol), means for receiving messages defined in said SIP and comprising data required for call features, means for extracting said data from said received messages, and means for presenting said call features to a user of said IP endpoint based on said extracted data.
